(19) United States
(12) Patent Application Publication
(10) Pub. No.: US 2018/0363855 A1
(43) Pub. Date: Dec. 20, 2018

(54) CAP FOR PROTECTING A VALVE OF A CYLINDER OF PRESSURISED FLUID AND CYLINDER INCLUDING SUCH A CAP

(71) Applicant: L'Air Liquide, Société Anonyme pour I'Etude et I'Exploitation des Procédés Georges Claude, Paris (FR)

(72) Inventors: Antoine FRENAL, Evanville (FR); Renaud LIGONESCHE, Herblay (FR)

(21) Appl. No.: 15/768,075

(22) PCT Filed: Sep. 29, 2016
(86) PCT No.: PCT/FR2016/052484

§ 371 Date: Aug. 24, 2018

(30) Foreign Application Priority Data
Oct. 15, 2015 (FR) 1559790

(51) Int. Cl. F17C 13/04; F17C 13/00; F17C 13/02; F17C 1/00

(52) U.S. Cl. CPC F17C 13/04; F17C 13/003; F17C 13/025; F17C 13/028; F17C 1/00; F17C 2250/0491; F17C 2205/0165; F17C 2205/0308; F17C 2250/0426; F17C 2250/043; F17C 2201/0104

(57) ABSTRACT

A cap for protecting a valve of a cylinder of pressurized fluid is provided. The cap includes a rigid structure defining a protective space for the valve. The structure includes a lower end that attaches to the cylinder.

### CROSS REFERENCE TO RELATED APPLICATIONS

This application is a 371 of International Application PCT/FR2016/052484 filed Sep. 29, 2016, which claims priority to French Patent Application No. 1559799 filed Oct. 15, 2015, the entire contents of which are incorporated herein by reference.

### BACKGROUND

The present invention relates to a protective cap for a valve of a cylinder of pressurized fluid, and also to a cylinder of fluid comprising such a cap.

The invention relates more particularly to a protective cap for a valve of a cylinder of pressurized fluid, comprising a rigid structure delimiting a protective volume for a valve, said structure comprising a lower end that is intended to be fixed to the upper end of a cylinder of pressurized fluid.

In order to avoid accidents, the valves of cylinders of pressurized fluid are generally protected by protective caps. These caps generally form a rigid cage for protecting the valve. The protective caps should be sufficiently protective while allowing manual and/or visual access to certain functions of the valve. Moreover, the caps should preferably have good ergonomics for handling the cylinder.

### SUMMARY

An aim of the present invention is to propose a protective cap that improves all or some of the above functionalities.

To this end, the cap according to the invention, which is otherwise in accordance with the generic definition thereof given in the above preamble, is essentially characterized in that the cap has a first wall forming a central tubular portion, said tubular portion extending between the lower end and an open upper end delimiting an access orifice for accessing an internal volume intended to shelter a valve, the cap also comprising a second wall that is disposed concentrically in a spaced-apart manner around the first wall and delimits a protective zone around the first wall.

Furthermore, embodiments of the invention may include one or more of the following features:
the first wall and second wall are in one piece or fixed rigidly together,
the second wall comprises an annular portion that is disposed concentrically around the first wall and is connected to the first wall via a plurality of connecting arms,
the connecting arms each have an end connected to the annular portion and an end connected to the lower part of the first portion, notably at the lower end of the cap,
in a vertical direction (A) extending between the lower end of the cap and the upper end of the cap, the upper end of the first wall delimiting the access orifice protrudes above the second wall,
the upper end of the first wall protrudes above the second wall by a distance of between 10 and 60 mm,
at least a part of the tubular portion formed by the first wall is cylindrical,
the second wall is spaced apart from the first wall by a distance of between 20 and 50 mm,
at least a part of the peripheral surface of the first wall has a display member for displaying information indicating the quantity of fluid contained in the cylinder on which the cap is mounted, the display member comprising at least two different display states corresponding to two different quantities of fluid, respectively,
the first wall has a cylindrical upper portion and a lower portion that flares toward the lower end and is intended to be fixed to the upper end of a cylinder, notably to the neck of a cylinder,
at least a part of the first wall and/or of the second wall is able to rotate or turn relative to the rest of the cap.

The invention also relates to a cylinder of pressurized fluid, comprising an orifice in which a valve is mounted, the cylinder comprising a protective cap that is connected to the cylinder and forms a protective enclosure around the valve, the cap being in accordance with any one of the features above or below, the valve being housed in the tubular portion delimited by the first wall.

According to further possible particular features:
the first wall is disposed concentrically around the valve and spaced apart from the latter by a distance of between 10 and 30 mm.

The invention may also relate to any alternative device or method comprising any combination of the features above or below.

### BRIEF DESCRIPTION OF THE DRAWINGS

For a further understanding of the nature and objects for the present invention, reference should be made to the following detailed description, taken in conjunction with the accompanying drawings, in which like elements are given the same or analogous reference numbers and wherein:

FIG. 1 shows a schematic and partial view in vertical section illustrating a first exemplary embodiment of a cap according to the invention,

FIG. 2 shows a schematic and partial view, partially in vertical section, of a cylinder of pressurized fluid provided with a cap in accordance with FIG. 1,

FIG. 3 shows a schematic and partial perspective view of the upper end of a cylinder of pressurized fluid provided with a cap in accordance with FIG. 1 in another possible embodiment,

FIG. 4 shows a schematic and partial view in vertical section of the upper end of the cylinder of pressurized fluid in FIG. 3,

FIG. 5 shows a schematic and partial perspective view of the upper end of a cylinder of pressurized fluid provided with a cap in accordance with FIG. 1 in yet another possible embodiment,

FIG. 6 shows a schematic and partial view in vertical section of a detail of the cylinder in FIG. 5,

FIG. 7 shows a schematic and partial side view illustrating a detail of the cylinder in FIGS. 5 and 6 illustrating a possible example of several pieces of information that are able to be displayed at the cap,

FIG. 8 shows a schematic and partial view in vertical section illustrating another exemplary embodiment of a cap according to the invention,

FIG. 9 shows a schematic and partial view in vertical section illustrating another exemplary embodiments of a cap according to the invention,

FIG. 10 shows a schematic and partial side view illustrating an example of deformation of the cap in the event of impacts or dropping.

FIG. 11 shows a schematic and partial side view illustrating another example of deformation of the cap in the event of impacts or dropping.

### DESCRIPTION OF PREFERRED EMBODIMENTS

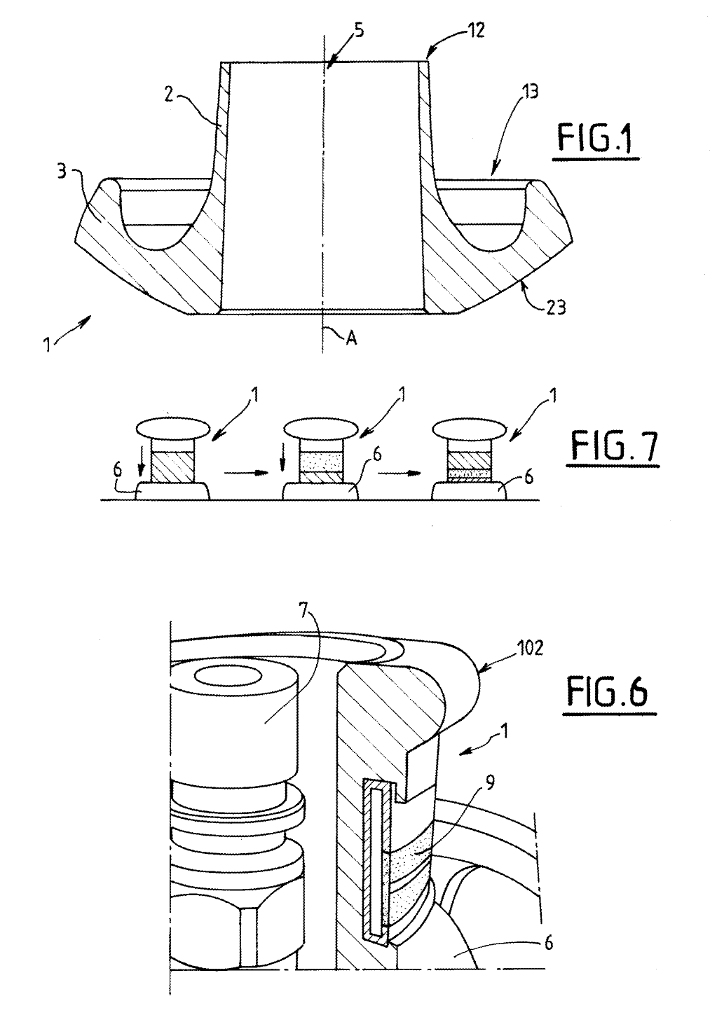

The protective cap 1 illustrated schematically in FIG. 1 comprises a rigid structure delimiting a central protective volume for a valve. This structure has a lower end 4 intended to be fixed to the upper end of a cylinder of pressurized fluid, notably at the neck of a cylinder having a cylindrical overall shape and comprising an end in the form of an ogive. Conventionally, the cap 1 can be screwed and/or tightened onto the neck of a cylinder.

According to one advantageous particular feature, the cap 1 has a first wall 2 that forms a central tubular portion. In the use position on a vertical cylinder, this tubular portion extends vertically around an axis A.

This tubular portion extends between the lower end 4 of the cap and an upper end 12. The upper end of the central tubular portion is open, i.e. delimits an access orifice 5 for accessing the internal volume of the tube. This orifice 5 may, if necessary, be closed by a removable cover.

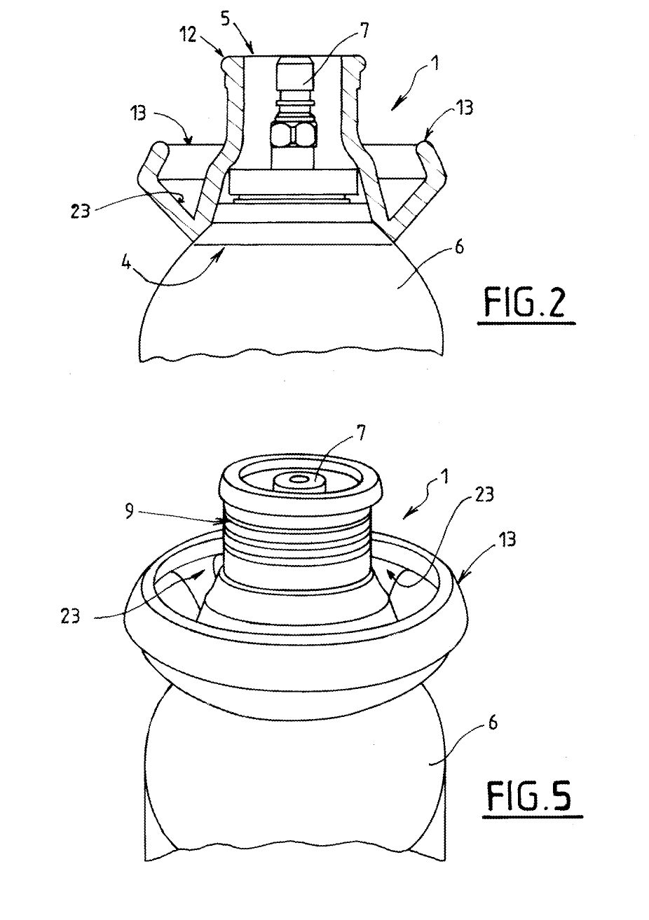

This internal volume of the tubular portion is intended to shelter a valve (cf. FIG. 2). This valve may be a simple coupling for connecting to the high pressure contained in a cylinder 6.

For example, at least a part of the tubular portion formed by the first wall 2 is cylindrical.

The first wall 2 has for example a cylindrical upper portion (solid or perforated) and a lower portion which flares toward the lower end 4 of the cap and is intended to be fixed to the upper end of a cylinder.

The cap 1 also comprises a second wall 3 that is disposed concentrically in a spaced-apart manner around the first wall 2. This second wall 3 delimits a protective zone for the first wall 2.

The second wall 3 is for example spaced apart transversely from the first wall 1 by a distance of preferably between 20 and 100 mm, for example between 20 and 50 mm, notably to allow the fingers or hands of a user to pass through.

The first wall 2 and second wall 3, which are made for example of metal and/or plastics material, are in one piece or fixed rigidly together (by molding, welding, assembling or by any other appropriate method).

As illustrated in the figures, the second wall 3 preferably comprises an annular portion 13 that is disposed concentrically around (and spaced apart from) the first wall 2 and is connected to the first wall via a plurality of connecting arms 23. For example, three or four connecting arms 23 are distributed angularly around the vertical axis A.

The connecting arms 23 each have for example an end connected to the annular portion 13 and an end connected to the lower part of the first portion 2, notably at the lower end 4 of the cap 1.

Between two adjacent arms 23, the second wall may be perforated. This means that openings allow access to the first wall 2.

This annular portion 13 thus forms additional mechanical protection around the valve. In addition, this annular portion likewise constitutes a manual handwheel that allows the cylinder to be handled, rolled or inclined.

Preferably in the direction of the vertical axis A of the cap, the upper end 12 of the first wall 2 protrudes above (beyond) the second wall 3.

For example, the upper end 12 of the first wall 2 protrudes above the second wall 3 by a distance of between 10 and 60 mm.

It is thus clear that, while having a simple and inexpensive structure, the cap 1 according to the invention has a solid mechanical structure allowing good protection for a valve while allowing easy handling.

In particular, notably when the first central wall 2 protrudes above the second wall 3, the tubular end of the first wall 2 (possibly provided with a circular rib) can also be handled in order to guide, roll or incline the cylinder 6.

According to one possible particular feature, at least a part of the peripheral surface of the first wall 2 can have a display member 8, 9 for displaying information indicating the quantity of fluid contained in the cylinder on which the cap is mounted.

The display member 8, 9 comprising at least two different display states that correspond to two different quantities of fluid, respectively (empty/full or two filling levels above and below a threshold: 5% or 10% or 20% or any other appropriate value).

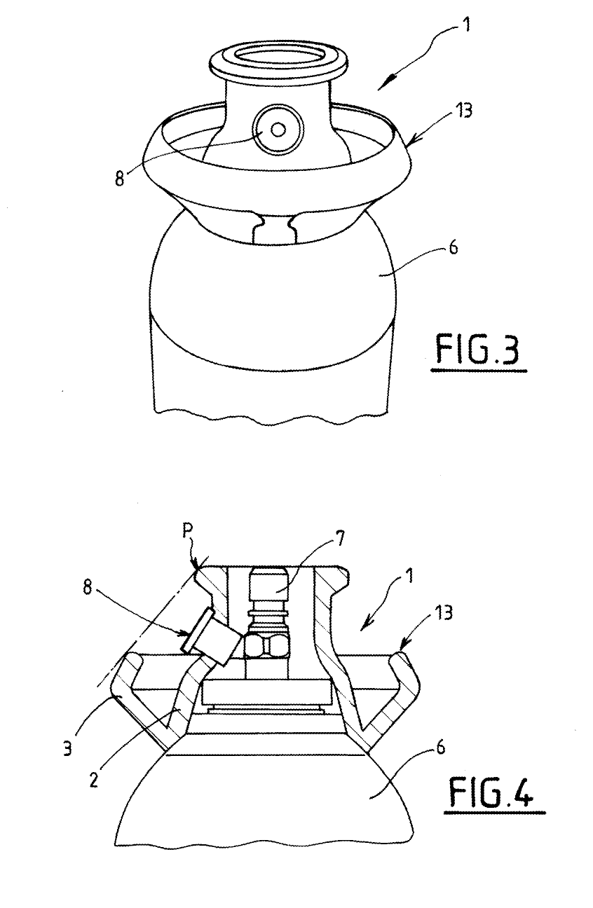

As illustrated in the example in FIGS. 3 and 4, the display member 8 may comprise a manometer that displays a pressure level or content level (via a needle or a digital display or display of color(s)).

Preferably, the display member 8 opens at least partially onto the first wall above the second wall 3. In this way, the information indicating the quantity of fluid stored in the cylinder 6 is visible even from a distance.

As can be seen in FIGS. 3 and 4, the manometer 8 may be incorporated into the first wall 2 (through the latter). In particular, the manometer 5 may be connected to the pressurized circuit of the valve which communicates with the interior of the cylinder 6 in order to continuously read the pressure within the cylinder 6. Of course, alternatively, the display of the pressure or the content can be obtained by a remote pressure measuring member or the like which sends this information wirelessly or via a wire to the manometer 8, which displays it fixedly or dynamically.

In the variant illustrated in FIGS. 5 to 7, the display member 9 comprises an electronic display, notably electronic paper (e-paper). This display 9 is preferably likewise placed on the external surface of the first wall 2, for example in a circumferential housing set back slightly toward the inside of the cap 1. Also in this way, the display member 9 is perfectly visible (for example through 360 degrees around the axis A) while being protected. Alternatively or additionally, it is possible to provide one or more display members on the peripheral portion of the second wall 3, notably on the annular portion. As above, this or these display member(s) may be of the electronic and/or mechanical type and be connected by a gas network or the like (network of capillaries for example) to the high pressure in the cylinder or the valve 7.

The display of the pressure or of the content may be explicit or may be symbolized by color codes, contrasts, alphanumeric symbols (cf. FIGS. 5 and 6: several adjacent strips that are or are not shaded).

As shown schematically in FIG. 7, the color codes or codes involving shades of the same color can symbolize several filling levels.

As before, the information displayed may be that measured in the cylinder by a pressure measuring member or the like which is or is not remote and sends this information wirelessly or via a wire to the member 9 displays it fixedly or dynamically.

As shown schematically in FIG. 4, the display member 8, 9 is disposed preferably between the two walls 2, 3. More specifically, the display member is preferably situated in a manner set back with respect to the plane P tangential to both the upper (and/or lateral) ends of the two walls 2, 3. In this way, the display member 8, 9 is always protected and sheltered if the cylinder 6 is dropped on the ground.

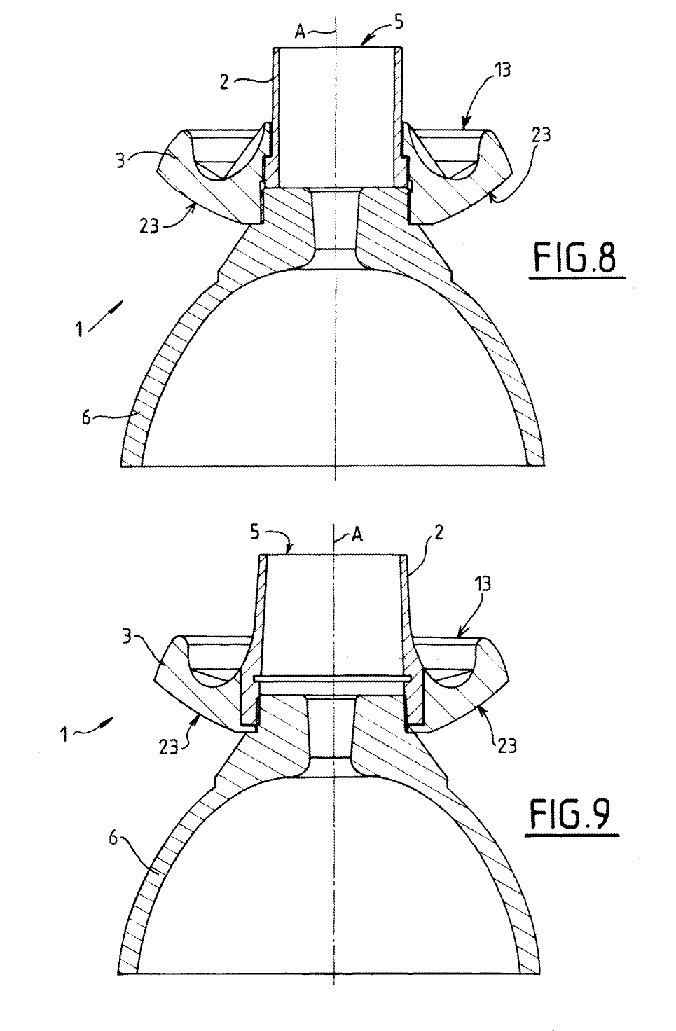

Of course, the invention is not limited to the examples described above. In particular, and as shown schematically in FIGS. 8 and 9, the cap 1 can be formed of two parts or more than two parts (three, four, etc.) that are assembled together.

In the embodiment in FIG. 8, the first wall 2 and the second wall 3 form separate entities that are assembled together. The first wall 2 is for example positioned on the cylinder 6 (around the valve) and the second wall 3 is attached to the first wall 2 and is fixed (for example by screwing) to the cylinder 6. In other words, the first wall 2 in the form of a tube is locked on the cylinder 6 via the second wall 3 (for example in the form of a handwheel) which is screwed onto the neck of the cylinder 6.

In the variant embodiment in FIG. 9, the first wall 2 and second wall 3 are likewise different entities that are assembled together. The second wall 3 is for example placed firstly on the end of the valve 6 and is then enclosed by the first wall 2 which is fixed (preferably screwed) to the neck of the cylinder 6.

In other words, one of the walls 2, 3 (or both if necessary) is fixed (screwed) to the cylinder and holds the other wall.

Without implying any limitation, the second wall 3 is for example molded, while the first wall 2 can be produced by conventional turning. The first wall 2 and second wall 3 may if necessary be formed of different respective materials (metal/plastic, etc.). Repeat machining operations can thus be concentrated on the part that has already been manufactured by turning.

In an advantageous variant, a part of the cap 1 may be able to rotate about the central axis A. In other words, a part of the cap 1 may form a turning knob making it easier to handle manually.

For example, in the embodiment in FIG. 8, the first wall 2 may be mounted so as to be free to rotate with respect to the second wall 3 and to the cylinder 6.

In the embodiment in FIG. 9, the second wall 3 may be mounted so as to be free to rotate about the first wall 2 and the cylinder 6.

In a variant or in combination, the upper end of the first wall 2 may comprise an annular part that is mounted so as to be free to rotate about the axis A with respect to the rest of the cap 1. For example, as can be seen in FIG. 6, the upper end of the first wall 2 make have a lip 102 that extends radially toward the outside of the cap 1, forming a gripping zone. This lip 102 being able to rotate, if necessary, with respect to the rest of the cap 1.

Similarly, it is conceivable for only the annular portion 13 of the second wall 3 to be rotatable on itself about the first wall 2.

The structure according to the invention also allows resistance to impacts (absorption of impact energy in the event of dropping).

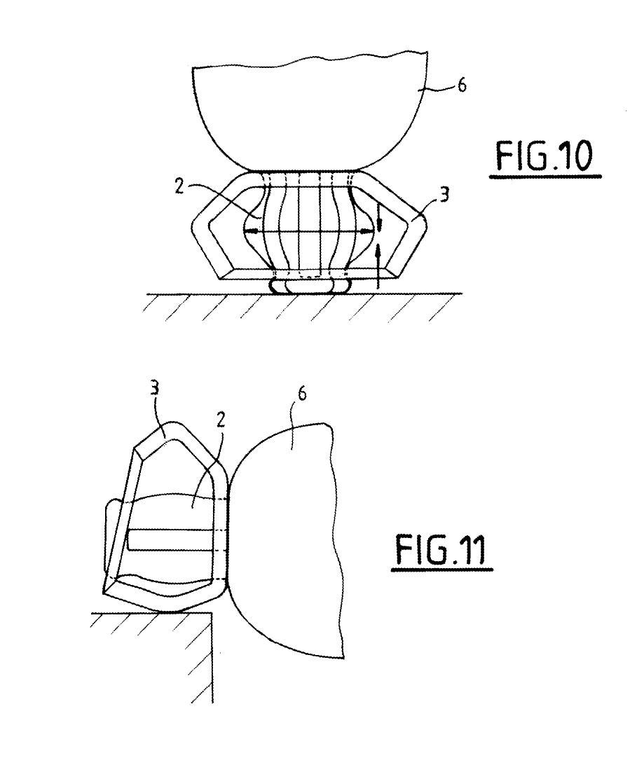

Thus, for example, in the event of vertical dropping on the cap (axis of the cylinder vertical or substantially vertical), the first wall 2 deforms preferably by widening and/or shortening (FIG. 10). Planned cracks may even be provided in the first wall 2 via narrowed portions or folding zones located on the first wall 2 (for example on the model of the structure of “hollow wall anchors”).

In the event of a lateral impact on the cap, the deformation and thus the absorption of the impact is ensured preferably by the second wall 3 (for example by lengthening and/or flattening of the second wall (see FIG. 11)). The first wall and the valve 7 thus remain preserved.

In the event of an impact on the cap at an angle (between axial vertical dropping and lateral impact), the forces and deformations are distributed within the two walls 2, 3 as per the embodiments above.

It will be understood that many additional changes in the details, materials, steps and arrangement of parts, which have been herein described in order to explain the nature of the invention, may be made by those skilled in the art within the principle and scope of the invention as expressed in the appended claims. Thus, the present invention is not intended to be limited to the specific embodiments in the examples given above.

1.-13. (canceled)

14. A cylinder of pressurized fluid, comprising:
an orifice in which a valve is mounted,
a protective cap that is fixed at the upper end of the cylinder and forms a protective enclosure around the valve,
the cap being formed of a rigid structure delimiting a protective volume for the valve, the lower end of the rigid structure being fixed to the upper end of the cylinder,
wherein
the rigid structure has a first wall forming a central tubular portion,
the valve being housed in the tubular portion delimited by the first wall with a space between the valve and the tubular portion,
the tubular portion extending between the lower end and an open upper end delimiting an access orifice for accessing the internal volume sheltering the valve,
the rigid structure further comprising a second wall that is disposed concentrically in a spaced-apart manner around the first wall and delimits a protective zone around the first wall, the second wall comprising an annular portion that is disposed concentrically around the first wall and is connected to the first wall via a plurality of connecting arms, the connecting arms each having an end connected to the annular portion and an end connected to the lower part of the first wall, the annular portion comprising a manual handwheel spaced apart from the first wall.

15. The cylinder as claimed in claim 14, wherein the first wall and second wall are in one piece or fixed rigidly together.

16. The cylinder as claimed in claim 14, wherein, in a vertical direction extending between the lower end of the cap and the upper end of the cap, the upper end of the first wall delimiting the access orifice protrudes above the second wall.

17. The cylinder as claimed in claim 14, wherein the upper end of the first wall protrudes above the second wall by a distance of between 10 and 60 mm.

18. The cylinder as claimed in claim 14, wherein at least a part of the tubular portion formed by the first wall is cylindrical.

19. The cylinder as claimed in claim 14, wherein the second wall is spaced apart from the first wall by a distance of between 20 and 100 mm.

20. The cylinder as claimed in claim 14, wherein the annular portion is spaced apart from the first wall by a distance of between 20 and 150 mm.

21. The cylinder as claimed in claim 14, wherein the first wall has a cylindrical upper portion and a lower portion that flares toward the lower end and is fixed to the upper end of a cylinder.

22. The cylinder as claimed in claim 14, wherein at least a part of the first wall and/or of the second wall is able to rotate or turn relative to the rest of the cap.

23. The cylinder as claimed in claim 14, wherein the first wall is disposed concentrically around the valve and spaced apart from the latter by a distance of between 10 and 50 mm.

24. The cylinder as claimed in claim 14, wherein the cap is fixed to the cylinder only via a mechanical connection between the lower end of the rigid structure and the upper end of the cylinder.

25. The cylinder as claimed in claim 14, wherein the upper end of the cylinder has a neck, and wherein the cap is fixed to the neck.

26. The cylinder as claimed in claim 25, wherein the cap is screwed and/or tightened onto the neck of the cylinder.
